(19) United States
(12) Patent Application Publication
(10) Pub. No.: US 2004/0066495 A1
(43) Pub. Date: Apr. 8, 2004

(54) Color wheel assembly

(76) Inventors: Joseph Yu, Taichung City (TW); Jason Chen, Feng-Yuan City (TW)

Correspondence Address: BIRCH STEWART KOLASCH & BIRCH, PO BOX 747, FALLS CHURCH, VA, 22040-0747, US

(21) Appl. No.: 10/263,793

(22) Filed: Oct. 4, 2002

(51) Int. Cl. G03B 21/14

(52) U.S. Cl. 353/84

(57) ABSTRACT

A color wheel assembly comprises a color wheel and a fixing ring. The color wheel comprises an annular disc and a plurality of filter lenses surrounding the annular disc. The filter lenses are attached to one another with an adhesive material. The fixing ring secures the color wheel from a top and a bottom of the color wheel. Thereby, when the color wheel rotates at high speed in a high-temperature atmosphere, the filter lenses, secured by the lower ring and the upper ring, remains securely attached to one another.

### FIELD OF THE INVENTION

The invention relates to an optical device used in projector equipment. More specifically, the invention relates a color wheel assembly used in projector equipment for filtering light.

### BACKGROUND OF THE INVENTION

Different types of projector include CRT projectors, LCD projectors and DLP projectors. FIG. 1 is a schematic view of a conventional DLP projector. As shown, in such a projector, a light beam is emitted from a light source such as a bulb, and then passes through a color wheel 2 to be divided into basic colors of red light, green light, and blue light. The lights are uniformly distributed by a focus system 3 and form an image on a digital micro-mirror device (DMD) 5 through a lens 4. Finally, the image is projected through a view lens 6.

It is noted that the structural quality of the color wheel 2 is related to the color quality of the projected image. FIG. 2 is a perspective view of a conventional color wheel. As shown, the color wheel 2 includes a disc 8 and a filter lens module 9. The disc 8 is provided with a flange 7 thereon. The filter lens module 9 has a central hole which receives the flange 7 after an adhesive material is applied on a surface 8A of the disc 8. The filter lens module 9 is thereby attached on the surface 8A to form the color wheel 2.

The filter lens module 9 includes a plurality of filter lenses 9A that are attached to one another with an adhesive. The color wheel 2 rotates at high speed and releases a substantial amount of heat while filtering light. The heat melts the adhesive at the connections of the filter lenses 9A, which thereby forms gaps 9B. As shown in FIG. 3, the resulting separation of the filter lenses 9A starts at a peripheral edge of the filter lens module 9 and continues toward the center of the filter lens module 9 along the gaps 9B. Once the filter lenses 9A of the module 9 no longer are attached to one another, the color quality of the image projected by the color wheel 2 is degraded.

Therefore, there is a need to provide a color wheel assembly that can secure the attachment of the filter lenses when the color wheel 2 rotates at high speed.

### SUMMARY OF THE INVENTION

Accordingly, it is an object of the invention to provide a color wheel assembly that includes an annular color wheel and a fixing ring mounted in such a manner that when the color wheel rotates at high speed in a high-temperature atmosphere, the color wheel, secured by a lower ring and a upper ring of the fixing ring, remains adequately assembled.

To provide a further understanding of the invention, the following detailed description illustrates embodiments and examples of the invention, this detailed description being provided only for illustration of the invention.

### BRIEF DESCRIPTION OF THE DRAWINGS

The drawings included herein provide a further understanding of the invention. A brief introduction of the drawings is as follows:

FIG. 1 is a schematic view of a conventional DLP;

FIG. 2 is a perspective view of a conventional color wheel;

FIG. 3 is a perspective view showing a gap is generated between two filter lenses in a conventional color wheel;

FIG. 4 is a schematic exploded view of a color wheel assembly according to an embodiment of the invention;

FIG. 5 is a perspective view of a color wheel assembly according to an embodiment of the invention; and

FIG. 6 is a cross-sectional view of a color wheel assembly according to an embodiment of the invention.

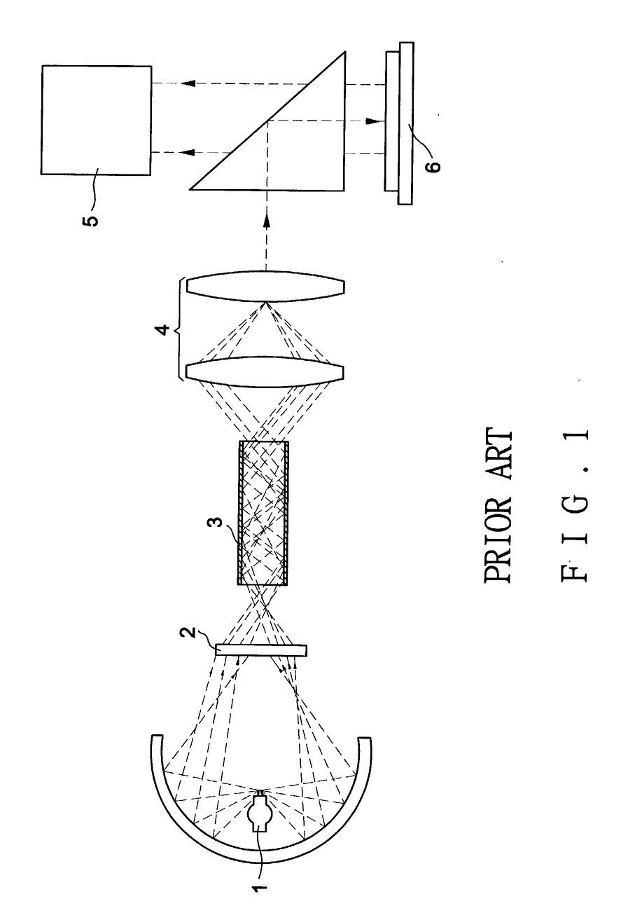

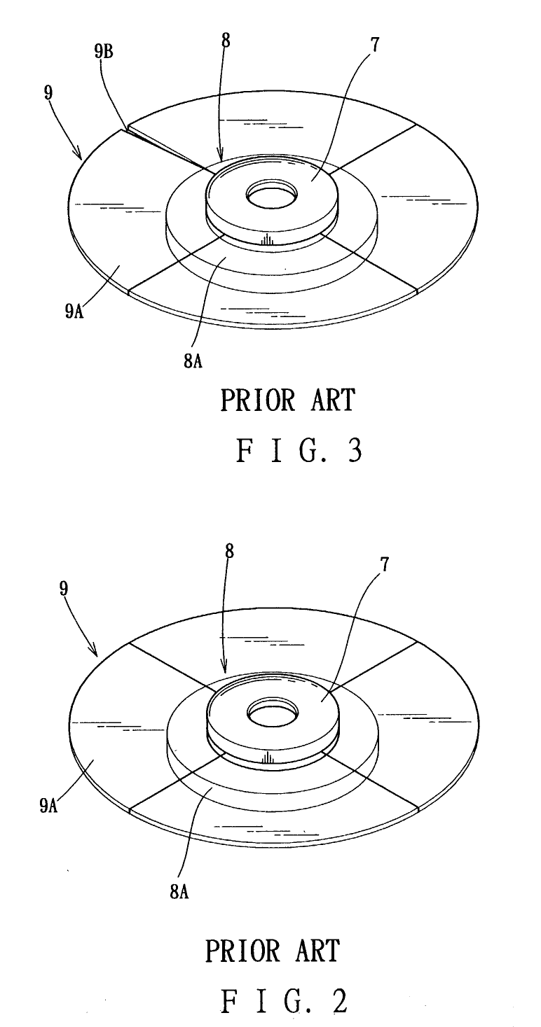

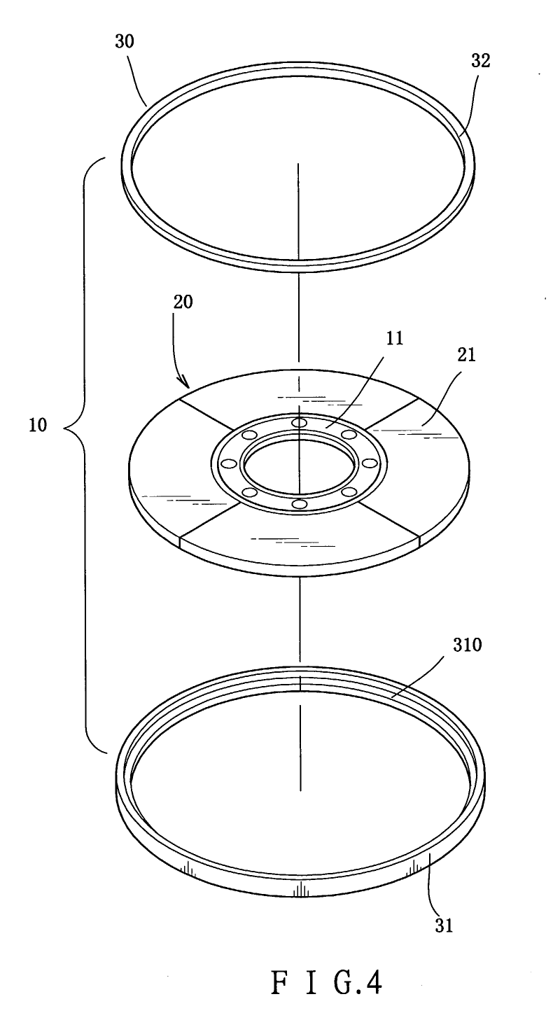

### DETAILED DESCRIPTION OF THE EMBODIMENTS

Wherever possible in the following description, like reference numerals will refer to like elements and parts unless otherwise illustrated.

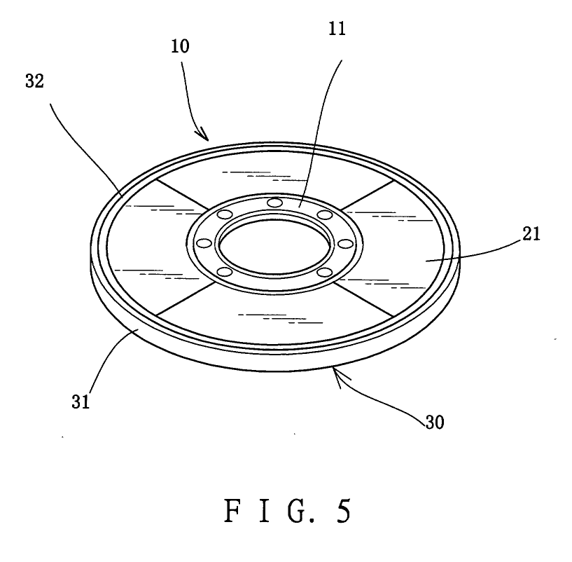

FIG. 4 is an exploded view of a color wheel assembly according to an embodiment of the invention. As shown, the color wheel assembly 10 according to the invention includes an annular color wheel 20 and a fixing ring 30. The color wheel 20 includes an annular disc 11 and a plurality of filter lenses 21. The filter lenses 21 are adjacently attached to one another via an adhesive material in a manner to surround the annular disc 11 and thereby form the annular color wheel 20. The fixing ring 30 includes a lower ring 31 and an upper ring 32. The lower ring 31 is provided with at least an engaging groove 310 that matches with the periphery of the upper ring 32.

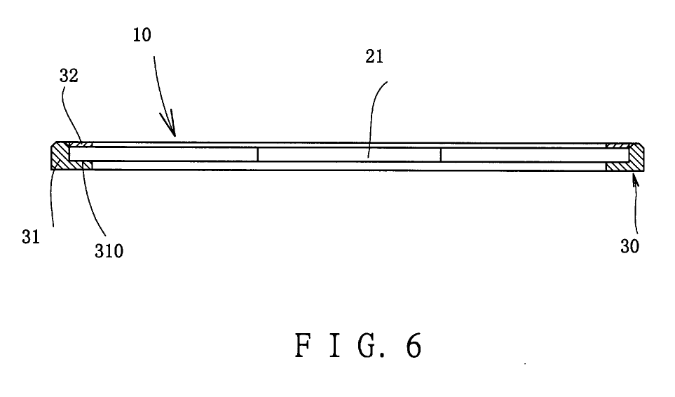

FIG. 5 is a perspective view of a color wheel assembly according to an embodiment of the invention. FIG. 6 is a cross-sectional view of a color wheel assembly according to an embodiment of the invention.

As shown, the color wheel 20 is placed in the engaging groove 310 of the lower ring 31. The upper ring 32 comes into contact with the peripheral edge of the filter lenses 21, and presses against the filter lenses 21 to attach the upper ring 32 and the lower ring 31.

Accordingly, since the fixing ring 30 secures the peripheral edge of the filter lenses 21 of the color wheel 20, the separation of the adjacent filter lenses 21 when the color wheel 10 rotates at high speed in a high-temperature atmosphere can be therefore prevented. In other words, even when the color wheel assembly 10 rotates at high speed in a high-temperature atmosphere, the annular color wheel 20, secured by the lower ring 31 and the upper ring 32, remains securely assembled. Therefore, the operation of the color wheel assembly 10 will not be adversely affected by the rotation of the color wheel 20.

It should be apparent to those skilled in the art that the above description is only illustrative of specific embodiments and examples of the invention. The invention should therefore cover various modifications and variations made to the herein-described structure and operations of the invention, provided they fall within the scope of the invention as defined in the following appended claims

What is claimed is:

1. A color wheel assembly, comprising
an annular color wheel, including an annular disc and a plurality of filter lenses mounted in a manner to surround the annular disc, wherein the filter lenses are attached to one another via an adhesive material; and
a fixing ring, securing the color wheel from a top and a bottom of the color wheel.

2. The color wheel assembly of claim 1, wherein the fixing ring further comprises an upper ring and a lower ring, wherein the lower ring is provided with an engaged groove that matches with a periphery of the upper ring, so that the filter lenses are secured by the lower ring and the upper ring when the filter lens module is placed on the lower ring.
